(19) United States
(12) Patent Application Publication
(10) Pub. No.: US 2025/0222470 A1
(43) Pub. Date: Jul. 10, 2025

(54) HIGH-PRESSURE LIQUID ROTARY NOZZLE WITH FRICTION BRAKE

(71) Applicant: STONEAGE, INC., Durango, CO (US)

(72) Inventor: Joseph A. SCHNEIDER, Durango, CO (US)

(21) Appl. No.: 19/016,359

(22) Filed: Jan. 10, 2025

Related U.S. Application Data
(60) Provisional application No. 63/619,625, filed on Jan. 10, 2024.

(51) Int. Cl. B05B 3/00; B05B 3/06

(52) U.S. Cl. CPC B05B 3/003; B05B 3/06

(57) ABSTRACT

A nozzle assembly for discharging high-pressure liquid. The nozzle assembly includes a housing body and a nozzle shaft rotatably mounted therein. A nozzle head is coupled to the nozzle shaft. The nozzle shaft and the nozzle head define a portion of a fluid pathway extending from an inlet end of the housing body to a set of directional nozzles disposed at a discharge end of the nozzle head. The nozzle shaft and the nozzle head are configured to rotate together in response to a discharge of a liquid from the set of directional nozzles. The nozzle assembly also includes a friction brake assembly housed within the housing body. The friction brake assembly converts a centrifugal force generated by a rotation of the nozzle shaft and the nozzle head into an axial force that reduces a rate of rotation of the nozzle shaft and the nozzle head into a desired range.

### CROSS-REFERENCE TO RELATED APPLICATION

This application claims the benefit of U.S. Provisional Application No. 63/619,625,filed on Jan. 10, 2024, entitled “High Pressure Liquid Rotary Nozzle with Friction Brake,” the technical disclosures of which is hereby incorporated by reference in its entirety.

### BACKGROUND

### Technical Field

Novel aspects of the present disclosure relate to the field of high-pressure fluid spraying applications, and more particularly to a rotary nozzle assembly for spraying high-pressure liquids and having a friction braking system driven by the rotary nozzle to act as a rotary speed retarder to prevent undesirable overspeed of nozzle operation.

### Background

In the field of high-pressure rotary liquid handling devices where the operating parameters can exceed 44,000 psi, rotating speeds of 5,000 rpm and flow rates of 25 gallons per minute (gpm), operating parameters relating to construction, cost, durability and ease of maintenance of rotating nozzles present many problems. High pressure water jet cleaning devices utilizing reaction force rotary nozzles tend to rotate at very high speeds. In many applications, such as surface preparation or cleaning operations it is desirable to slow down such rotary nozzle speed to maximize usable lifetime of the rotary nozzle and effectively improve the cleaning efficiency of such nozzles. A speed reducing device fastened to the rotating shaft of such rotary nozzles is often utilized to retard rotation of the nozzle. Combined length and diameter of such nozzles may not exceed a few inches. The more extreme operating parameters and great reduction in size compound the problems. Pressure, temperature and wear factors affect durability, ease of maintenance and attendant cost, and inconvenience and safety in use of such nozzle devices. Simple durable low cost and easily maintained speed-controlled nozzles are most desirable.

### SUMMARY OF THE INVENTION

Novel aspects of the present disclosure are directed to a nozzle apparatus that includes a housing body and a nozzle shaft rotatably mounted therein. A nozzle head is coupled to the nozzle shaft. The nozzle shaft and the nozzle head define a portion of a fluid pathway extending from an inlet end of the housing body to a set of directional nozzles disposed at a discharge end of the nozzle head. The nozzle shaft and the nozzle head are configured to rotate together in response to a discharge of a liquid from the set of directional nozzles. The nozzle assembly also includes a friction brake assembly housed within the housing body. The friction brake assembly converts a centrifugal force generated by a rotation of the nozzle shaft and the nozzle head into an axial force that reduces a rate of rotation of the nozzle shaft and the nozzle head.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the disclosure are set forth in the appended claims. A preferred mode of use, further objectives and advantages thereof, will be best understood by reference to the following detailed description of illustrative embodiments when read in conjunction with the accompanying figures, wherein:

FIG. 1 is a perspective view of the nozzle apparatus assembly in accordance with an illustrative embodiment;

FIG. 2 is a lateral view of the nozzle apparatus assembly of FIG. 1 but with the housing body removed;

FIG. 3 is a perspective view of the housing body which shows the enclosable chamber defined therein;

FIG. 4 is a cross-sectional view of the nozzle apparatus assembly of FIG. 1 in accordance with an illustrative embodiment;

FIG. 5 is an exploded perspective view of the nozzle apparatus assembly in accordance with an illustrative embodiment;

FIG. 6 is an exploded lateral view of the nozzle apparatus assembly in accordance with an illustrative embodiment;

FIG. 7 is a lateral view of the nozzle head of the nozzle apparatus assembly in accordance with an illustrative embodiment;

FIG. 8 is an exploded perspective view of the friction brake assembly of the nozzle apparatus assembly in accordance with an illustrative embodiment;

FIG. 9 is another exploded perspective view of the friction brake assembly of the nozzle apparatus assembly in accordance with an illustrative embodiment;

FIG. 10 is an exploded lateral view of the friction brake assembly of the nozzle apparatus assembly in accordance with an illustrative embodiment;

FIG. 11 is a plan view of a lined friction disk of the friction brake assembly in accordance with an illustrative embodiment;

FIG. 12 is a plan view of a rotor disk of the friction brake assembly in accordance with an illustrative embodiment;

FIGS. 13A-13C are various views of an idler spider of the friction brake assembly in accordance with an illustrative embodiment;

FIG. 13D is a perspective view of the idler spider engaging a plurality of ball bearings in accordance with an illustrative embodiment;

FIGS. 14A-B are various views of a ramped disk of the friction brake assembly in accordance with an illustrative embodiment;

FIGS. 14C-D are various section views of the ramped disk of the friction brake assembly in accordance with an illustrative embodiment; and

FIG. 15A-C are various lateral cross-sectional views of the friction brake assembly in various stages of operation in accordance with an illustrative embodiment.

### DETAILED DESCRIPTION

Objects of this disclosure recognize the need for a nozzle apparatus assembly that can reduce the speed of rotation of a nozzle head and a tubular nozzle shaft rotatably mounted within an outer housing of the nozzle apparatus assembly, but without the need for a dedicated lubricating fluid, like automatic transmission fluid, contained therein. Rotational speed reduction can reduces wear and heat generation at the moving parts within the nozzle apparatus assembly.

Another object of the disclosure is to help achieve a durable, light weight, rotating high pressure spray nozzle assembly which can be conveniently carried on the end of a spray lance and used to prepare and/or clean a surface or irregularly shaped objects.

Another object of the disclosure is to provide a nozzle with a speed retarding mechanism having a friction-generation mechanism that provides lower braking forces at lower rotational speeds and torque inputs, and higher braking forces at higher rotational speeds and torque inputs.

Another object of the disclosure is to provide a durable rotation speed retarding mechanism for the rotating spray head in an elongated small diameter high pressure water spray assembly.

Another object of the disclosure is to provide an improved speed retarding mechanism for a rotating nozzle member of a small diameter high pressure spray nozzle assembly using a mechanism incorporating one or more centrifugal force converters that converts a centrifugal force into an axial force usable for nozzle head speed retardation control.

Another object of the disclosure is to provide a rotation speed retarding mechanism that can operate in the absence of a lubricating fluid filling the enclosable chamber.

The nozzle apparatus assembly described in this disclosure is intended for use in a high-pressure range of approximately 2,500-44,000 psi. Embodiments of the frictional braking assembly described herein can prevent overspeeding, i.e., the speed can be selectively kept in the range of about 500-5,000 rpm with an optimal speed of about 2,000 rpm for a spraying operation. Without practical maximum speed control, a runaway rotary nozzle can reach several thousand rpm which can detrimentally affect the spraying function and also rapidly increase wear of seals, bearings and other operating parts of nozzle apparatus assembly.

Ball bearings form axially spaced load distributing bearing means between a rotating tubular nozzle shaft and an inner cylindrical surface of a nozzle housing body. The bearings rotatably support the shaft coaxially within the housing body and prevent axial movement of the tubular nozzle shaft when subjected to high forwardly directed thrust forces from internal high liquid pressures at rotary seal members in the nozzle assembly.

The nozzle assembly apparatus includes a generally cylindrical housing body forming a relatively stationary reference structure with respect to a coaxial, rotatable tubular nozzle shaft that has an input end in sealed relationship with a connecting high pressure liquid input source, e.g., a high-pressure lance, via an internally threaded portion for receiving the threaded end of the high-pressure liquid input source, e.g., cone-and-thread or conventional pipe threads.

The cartridge assembly contains the high working pressure of the high-pressure spray liquid at the inlet end of the nozzle apparatus assembly and prevents the escape of high-pressure liquid from the intended liquid flow path passage into the inlet end of the tubular nozzle member. The cartridge assembly used permits easy replacement of a single plastic seal member with O-ring when it is worn at a small fraction of the cost of replacement of the durable seat. The durable seat, which can be formed from carbide, is pressed axially against and rotates with the nozzle shaft during operation of the spray nozzle apparatus. The cartridge assembly depicted herein is exemplary and should not be deemed limiting.

The cartridge assembly comprises the inlet seat housing, the axially slidable seal, and the durable seat. The design of the cartridge assembly provides a very effective seal at low cost because of the simplicity of configuration of these three principal parts and their manner of retention, and replacement when necessary, after wear, during the life of the nozzle structure. Wear of 50% of the axially slidable seal, which can be formed from plastic, is tolerated without degradation of sealing by this assembly.

A rotational speed control means for the nozzle apparatus assembly is contained in an enclosable chamber which encloses ball bearing means for rotatably supporting the rotatable tubular nozzle shaft that carries the spray liquid to the nozzle head. This enclosable chamber is sealed to protect the bearings and speed control mechanisms from any liquid which might escape from the spray liquid passages within the housing body as well as any liquid from the environment.

The enclosable chamber is sealed at the discharge end of the housing body by a removable front cap and an annular shaft seal between the outer surface of the tubular nozzle shaft and an inner surface of the removable front cap. The inlet end of the enclosable chamber is sealed by a shaft seal between the tubular nozzle shaft and a necked portion of the housing body.

The various internal elements in the enclosable chamber of the nozzle apparatus assembly, including the bearings, are kept in relatively fixed axial positions by means including the removable front cap, which, when properly seated, pushes all such elements toward the inlet end of the housing body where the inlet end radial bearing abuts an inwardly-extending housing body shoulder. A wave spring accommodates the tolerance stack and biases the elements forward toward the discharge end.

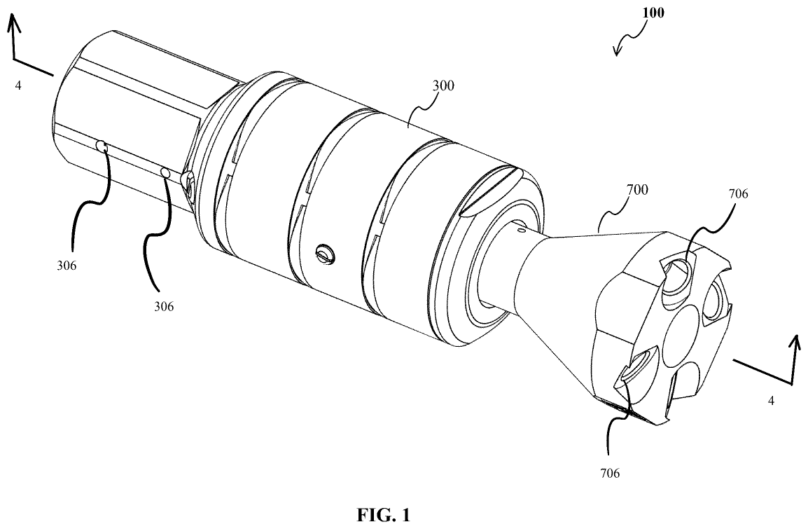

FIGS. 1, 2, and 4-6 are various perspective views of a high-pressure, liquid nozzle apparatus assembly 100 that can be connected to a source of high-pressure liquid, such as a spray lance. Generally, the discharge of pressurized liquid from a set of canted discharge nozzles 706 at the discharged end of the nozzle head 700 causes the nozzle head 700 to rotate during operation. As used herein, the term “set” means one or more. Thus, a set of canted discharge nozzles can be a single canted discharge nozzle, or two or more canted discharge nozzles.

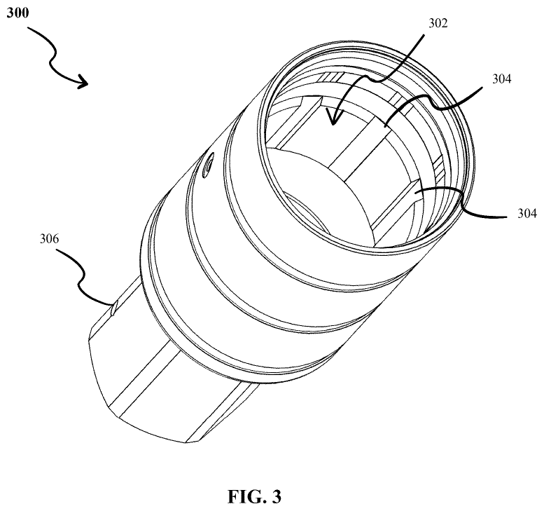

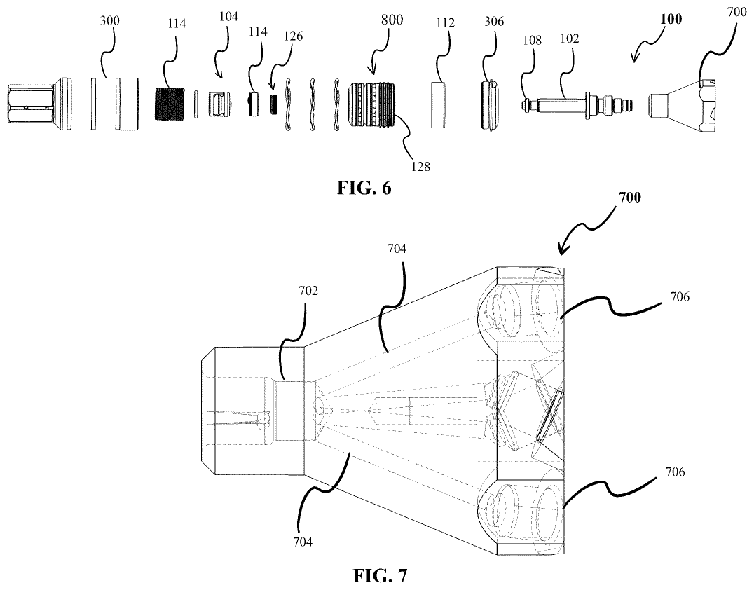

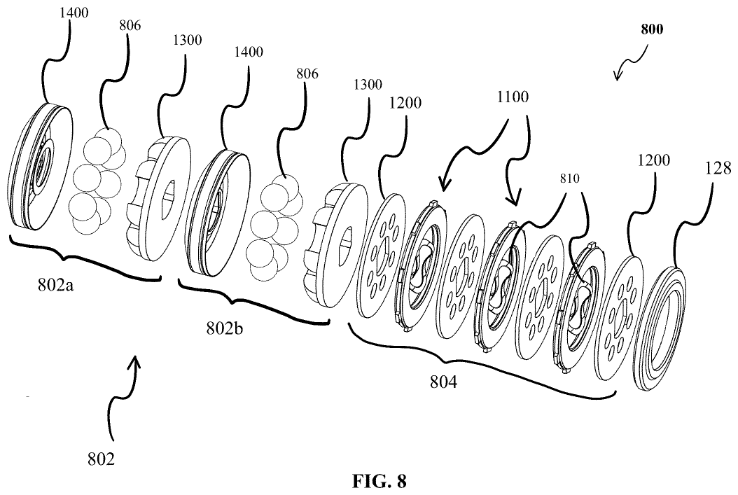

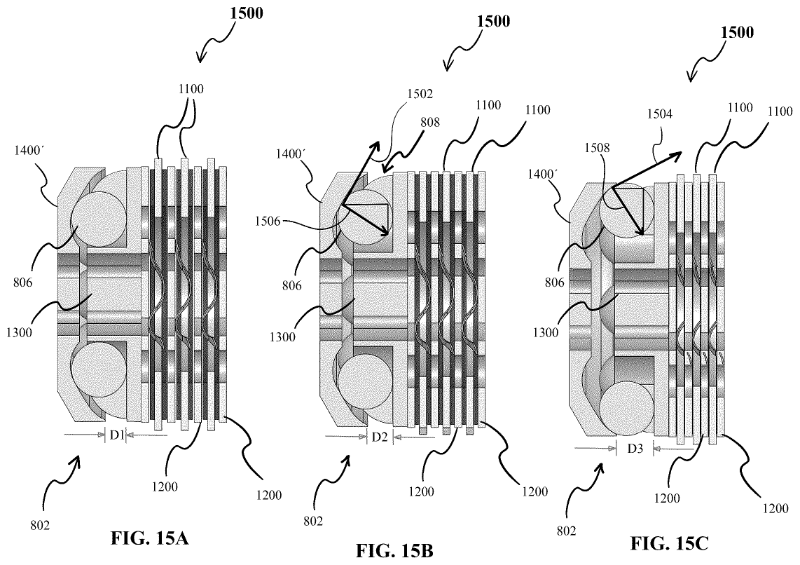

The nozzle head 700 is depicted in FIG. 7. To prevent rotation at excessive speeds, the nozzle apparatus assembly 100 houses a friction brake assembly 800 within an enclosable chamber 302, depicted in more detail in FIG. 3. The friction brake assembly 800, shown in FIGS. 8-15, reduces the rotational speed of the nozzle apparatus assembly 100 by converting a centrifugal force into an axial force that can be used to increase the frictional forces applied to one or more brake disks 804 of the friction brake assembly 800, as shown in FIGS. 15A-15C.

It is desirable to ensure that the torque produced by the discharge of high-pressure liquid from discharge nozzles 706 is within the operating limits of the nozzle apparatus assembly 100. The preferred tool operational torque range is from 4-30 in.-lb. and it is generally desirable not to exceed 35 in-lb of torque. The higher figure of 35 in-lb will provide more latitude for tolerable ranges of overall operating parameters. Too small a torque may result in erratic rotation rates or be insufficient to start rotation. Too large a torque will exceed the ability of the tool to govern rotation speed and may cause excessive heat buildup, temperature rise in the internal parts, and rapid seal and friction disk wear. Additionally, larger torques can result in excessive rotation speeds affecting the cleaning operation of the high-pressure water discharged from the nozzle head 700 of the nozzle apparatus assembly 100. The tool should not generally be operated at torques above 30 in-lb.

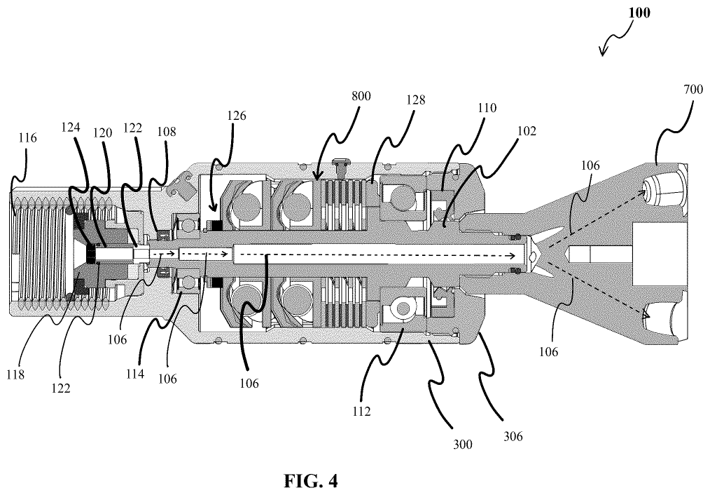

FIG. 1 is a perspective view of the nozzle apparatus assembly in accordance with an illustrative embodiment. The nozzle apparatus 100 is formed from an elongated cylindrical housing body 300 within which is rotatably mounted a tubular nozzle shaft 102 (shown in more detail in FIGS. 4-6 that follow). The tubular nozzle shaft 102 is fixedly attached to a nozzle head 700 so that rotation of the nozzle head 700 causes rotation of the tubular nozzle shaft 102. Rotation of the nozzle head 700 is caused by the discharge of pressurized liquid, i.e., jet streams, from a set of canted discharge nozzles 706. As used herein, the term “set” means one or more. Thus, the set of discharge nozzles 706 can be a single discharge nozzle or two or more discharge nozzles. In the non-limiting embodiment presented in this disclosure, the set of discharge nozzles 706 includes four discharge nozzles 706 arranged regularly about the discharge end of the nozzle head 700.

In a non-limiting embodiment, the set of discharge nozzles 706 are canted to impart a jet reaction torque, i.e., rotation, on the nozzle head 700 and also on the tubular nozzle shaft 102, which makes the nozzle head 700 and the tubular nozzle shaft 102 self-rotating. The direction of self-rotation in this illustrated embodiment is clockwise when looking into the discharge end of the nozzle assembly 100. The direction of rotation helps to maintain the nozzle head 700 screwed securely into the tubular nozzle shaft 102.

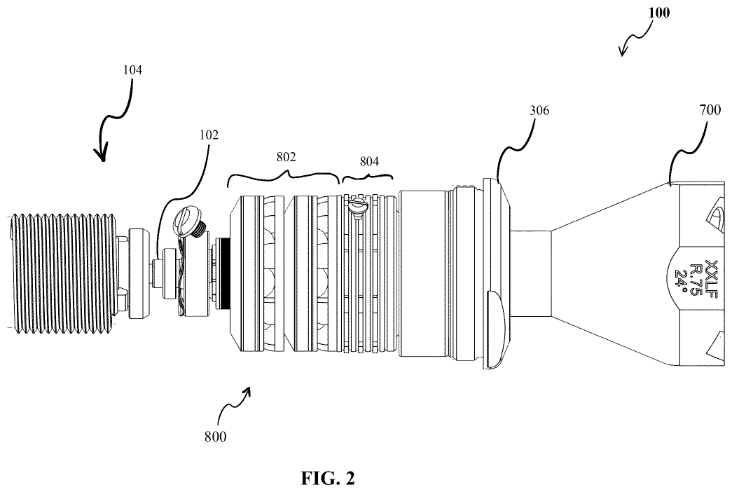

FIG. 2 is a lateral view of the nozzle apparatus assembly of FIG. 1 but with the housing body removed. At the inlet end of the nozzle apparatus assembly 100 is a cartridge assembly 104 configured to connect a source of high-pressure liquid, e.g., a lance hose (not shown), to a tubular nozzle shaft 102, which is in turn connected to nozzle head 700. As previously discussed, flow of pressurized fluid through the fluid flow path 106, causes the tubular nozzle shaft 102 and the nozzle head 700 to rotate. The fluid flow path 106 is shown in more detail in FIG. 4 and is represented by a series of arrows passing through the tubular nozzle shaft 102 and branching out in the nozzle head 700 to connect the inlet end of the nozzle assembly apparatus 100 to canted discharge nozzles 706 at its discharge end.

Disposed around the tubular nozzle shaft 102 is a friction brake assembly 800 that retards the rotational speed of the tubular nozzle shaft 102 and the nozzle head 700. As will be discussed in more detail in the figures that follow, the friction brake assembly 800 includes a set of centrifugal force converters 802 that converts a centrifugal force into an axial force that increases a braking force, i.e., frictional forces, imparted to a set of brake disks 804.

The tubular nozzle shaft 102, and the friction brake assembly 800 are housed within an enclosable chamber 302 formed by the housing body 300 and sealed by a front cap 306. As can be seen in the lateral cross-sectional view of the nozzle apparatus assembly 100 in FIG. 4, a discharge end of the tubular nozzle shaft 102 extends out of the enclosable chamber 302 from an aperture in the front cap 306. The discharge end of the tubular nozzle shaft 102 is coupled to the inlet end of the nozzle head 700.

FIG. 3 is a perspective view of the housing body which shows the enclosable chamber 302 defined therein. The enclosable chamber 302 is generally cylindrical. A set of axially oriented channels 304 is disposed regularly throughout the inner surface of the housing body 300. Each of the set of channels 304 is configured to receive a corresponding tooth 1108 from a brake disk, e.g., one or more lined friction disks 1100 in the depicted embodiments, or one or more rotor disks in an alternate embodiment where the lined friction disks are rotationally fixed to the nozzle shaft 102 and allowed to rotate relative to the rotor disks, which are rotationally fixed to the housing body 300. In a non-limiting embodiment, when a toothed, lined friction disk 1100 is mounted within the enclosable chamber 302, each of the teeth 1108 is engaged within a corresponding channel 304, which prevents rotational movement of the lined friction disk 1100 within the housing body 300 but permits axial movement of the lined friction disk 1100.

In some embodiments, the enclosable chamber 302 is run dry and the bearings housed within the enclosable chamber 302 can be sealed with internal lubrication. In other embodiments, the enclosable chamber 302 can be filled with a liquid or lubricant, which can help pull heat from the friction brake assembly, i.e., the brake disks, to the enclosable body 302 to increase heat dissipation. If the enclosable chamber 302 is filled with a lubricant, then the nozzle apparatus assembly can use open bearings.

FIG. 4 is a cross-sectional view of the nozzle apparatus assembly of FIG. 1, taken along line 4-4, in accordance with an illustrative embodiment. The housing body 300 defines an enclosable chamber 302 that is further sealed on opposing ends by shaft seals, i.e., a rear shaft seal 108 and a front shaft seal 110. The rear shaft seal 108 seals against the tubular nozzle shaft 102 and the housing body 300 and the front shaft seal 110 seals against the tubular nozzle shaft 102 and the front endcap 306 that is secured to the discharge end of the housing body 300.

The tubular nozzle shaft 102 is rotatably mounted within the housing body 300 by ball bearings mounted just inside the rear shaft seal 108 and the front shaft seal 110. In particular, the discharge end of the tubular nozzle shaft 102 is rotatably supported against the housing body 300 by the discharge end ball bearing 112, which can be angular contact ball bearings in a non-limiting embodiment, and the inlet end of the tubular nozzle shaft 102 is rotatably supported by the inlet end ball bearing 114 against the housing body 300.

The axial position of the tubular nozzle shaft 102 is also fixed within the housing body 300 by the discharge end ball bearing 112 and the inlet end ball bearing 114. In particular, axial movement in the direction of the discharge end is prevented by an outwardly extending annular shoulder that abuts against the inner race of the discharge end ball bearing 112, which has its outer race abutting the front endcap 306. Axial movement in the direction of the inlet end is prevented, at least in part, by a stepped shoulder abutting the inner race of the rear ball bearing 114, which abuts against a wave spring compressed against an inner shoulder of the outer housing 300.

A threaded interface 116 and/or a cartridge assembly 104 is located at the inlet end of the nozzle assembly apparatus 100 for removably engaging a high-pressure liquid input source, e.g., a fluid hose or lance (not shown), by conventional means, including but not limited to a cone-and thread connector, or conventional pipe threads. The cartridge assembly 104 includes an inlet seat housing 118 providing a connection interface with a terminal end of the high-pressure liquid input source, which is a smooth, conical surface in the depicted embodiment for engaging a cone-and-thread connector. Housed at least partially inside of the inlet seat housing 118 is an axially slidable seal 120 abutting a hard, durable seat 122 that engages the inlet end of the tubular nozzle shaft 102. In a non-limiting embodiment, the durable seat is formed from carbide.

When a high-pressure liquid input source is secured in the inlet end of the housing body 300, a sealed connection is formed against the conical entrance inlet seat housing 118. A pressurized liquid introduced into the cartridge assembly 104 is conveyed through the fluid flow path 106 extending through the tubular nozzle shaft 102 and the nozzle head 700 before being discharged through the canted discharge nozzles 706. Any leakage of high-pressure liquid outside of the axially slidable seal 120 and the durable seat 122 can escape through weep passages 306 in the housing body 300, shown in FIGS. 1 and 3.

The outside wall of the axially slidable seal 120 fits snugly against the wall of inlet seat housing 118. An O-ring seal 122 disposed within an annular groove in the axially slidable seal 120 not only provides additional sealing means between the outer surface of the axially slidable seal 120 and the inlet seat housing 118, but also aides in holding the axially slidable seal 120 in position against rotation as the axially slidable seal 120 is sealed against the durable seat 122. In the depicted embodiment, the durable seat 122 rotates with the tubular nozzle shaft 102 during operation of the nozzle apparatus assembly 100. As the end of the axially slidable seal 120 wears where it contacts the durable seat 122, an axial force directed towards the discharge end, e.g., by a spring 124 and/or a liquid pressure from the pressurized liquid flowing into the fluid flow path 106, assures sealed continuity at the input end of the tubular nozzle shaft 102.

Overspeed rotation of the tubular nozzle shaft 102 and the nozzle head 700 is prevented by the frictional brake assembly 800, as described in more detail in FIGS. 8 and 15A-15C. The axial position of the frictional brake assembly 800 is maintained by a set of shims 126 at the inlet end frictional brake assembly 800 and a support plate 128 at the discharge end of the frictional brake assembly 800. The shims can be adjusted to provide the correct amount of axial clearance needed for proper engagement and clearance between the brake disks 804.

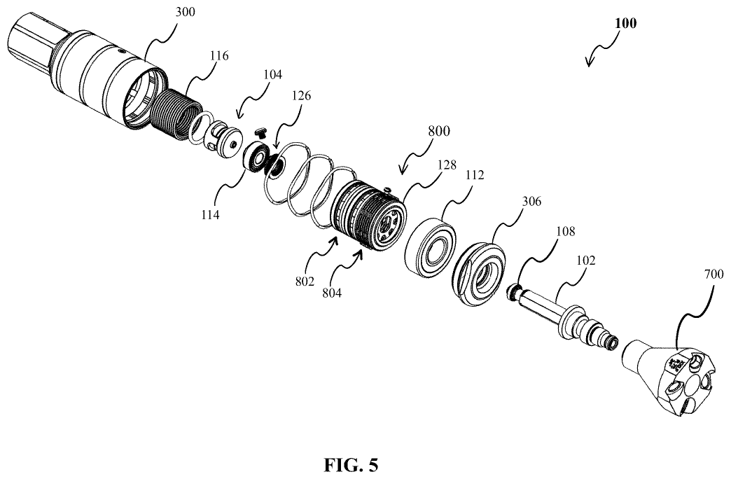

FIGS. 5 and 6 are various exploded views of the nozzle apparatus in accordance with an illustrative embodiment. In particular, FIG. 5 is an exploded perspective view of the nozzle apparatus assembly in accordance with an illustrative embodiment, and FIG. 6 is an exploded lateral view of the nozzle apparatus assembly in accordance with an illustrative embodiment.

FIG. 7 is a lateral view of the nozzle head of the nozzle apparatus assembly in accordance with an illustrative embodiment. The nozzle head 700 has a counterbore passage 702 sized to receive the discharge end of the tubular nozzle shaft 102. The counterbored passage 702 is connected to each of the canted discharge nozzles 706 by one of a plurality of branching conduits 704. Although not depicted, the canted discharge nozzles 706 can be configured to receive nozzle discharge tips to alter the spray of pressurized liquid from the nozzle head 700.

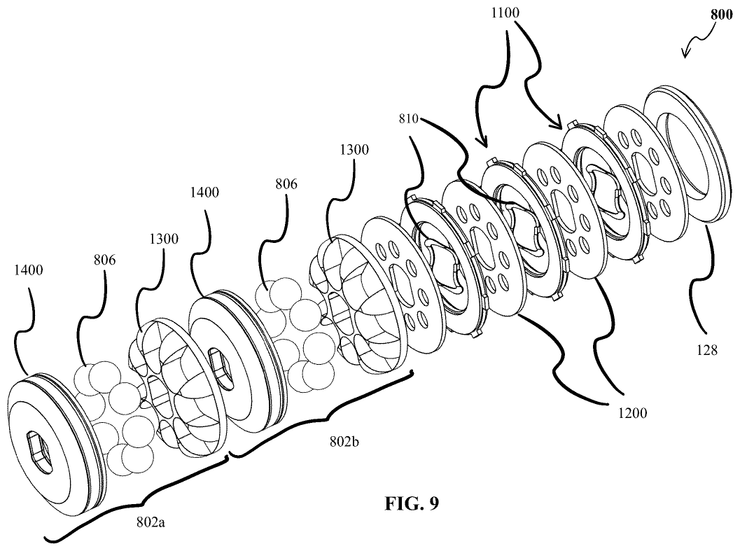

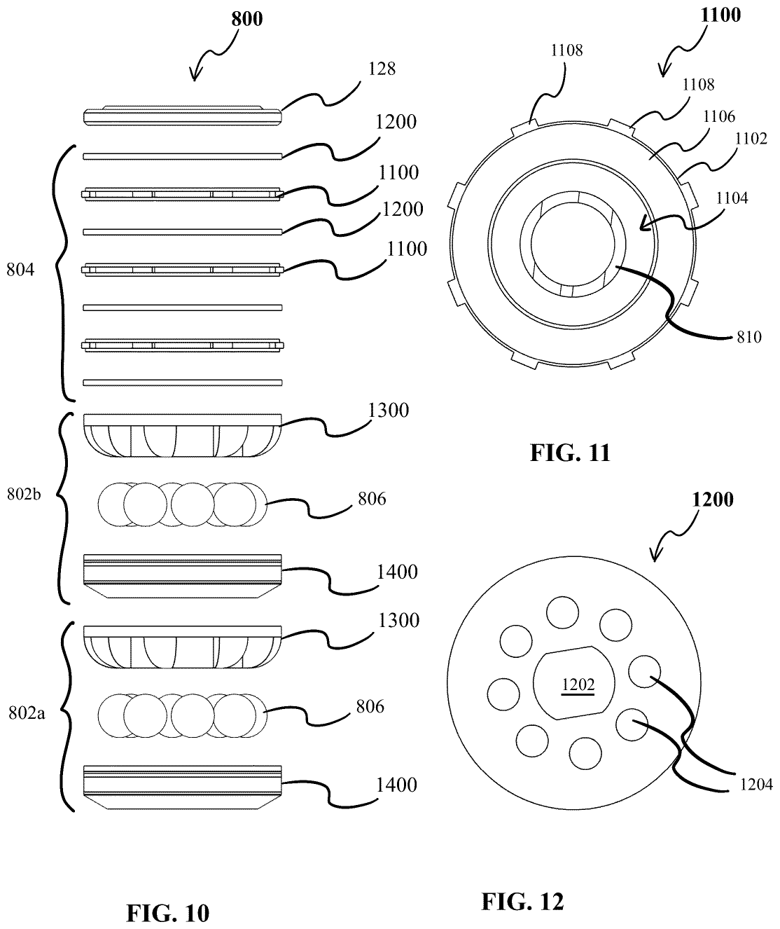

FIGS. 8, 9, and 10 are exploded views of the friction brake assembly of the nozzle apparatus in accordance with an illustrative embodiment. In particular, FIGS. 8 and 9 are various exploded perspective views of the friction brake assembly 800, and FIG. 10 is an exploded lateral perspective view of the friction brake assembly 800.

The friction brake assembly 800 is generally formed from a set of centrifugal force converters 802 and a set of brake disks 804. In the depicted embodiment, the set of centrifugal force converters 802 includes two centrifugal force converters 802a and 802b and the set of brake disks 804 includes a plurality of rotor disks 1200 and lined friction disks 1100.

The set of centrifugal force converters 802 are slidably engaged to the tubular nozzle shaft 102 but rotationally fixed relative to the tubular nozzle shaft 102 so that the rotation of the tubular nozzle shaft 102 causes the set of centrifugal force converters 802 to rotate in concert with the tubular nozzle shaft 102. At least some of the brake disks 804, e.g., rotor disks 1200 in the depicted embodiment, are also slidably engaged to the tubular nozzle shaft 102 and rotationally fixed relative to the tubular nozzle shaft 102 so that at least some of the brake disks 804 can rotate in concert with the tubular nozzle shaft 102. The remaining portion of the brake disks 804, e.g., lined friction disks 1100 in the depicted embodiment, are coaxially aligned about the tubular nozzle shaft 102 but slidably engaged to the housing body 300 and rotationally fixed relative to the housing body 300. In either embodiment, the brake disks 804 and the lined friction disks 1100 in alternating fashion. By allowing some of the brake disks 804 to rotate with the rotating tubular nozzle shaft 102 while the remaining brake disks 804 are maintained rotationally fixed, the amount of friction between the brake disks 804 can be increased in order to generate a braking force to slow down the rotation of the tubular nozzle shaft 102 and the nozzle head 700.

Each of the centrifugal force converters 802 is formed from one or more centrifugally responsive weights 806, each of which is housed within a separate guidance channel 808 that controls the direction of travel of the centrifugally responsive weights 806. By configuring each of the guidance channels 808 formed by the idler spider 1300 and the ramped disk 1400 to direct its corresponding centrifugally responsive weight 806 to travel in a direction that has an axial component, a portion of the centrifugal force is converted to an axial force. The guidance channel 808 is shown in FIGS. 15A-15C.

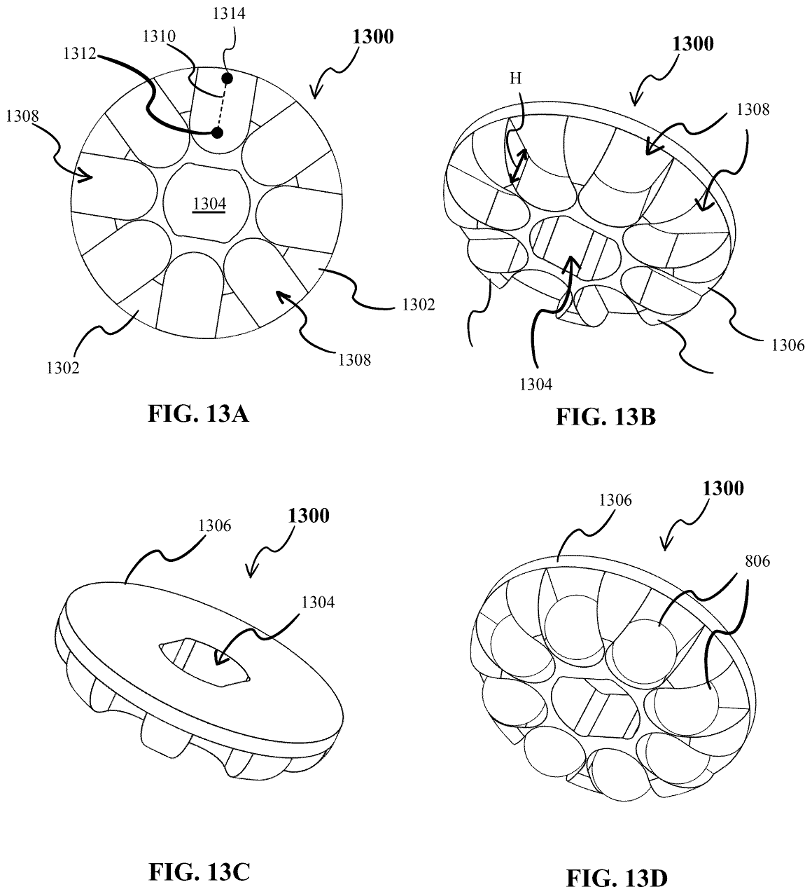

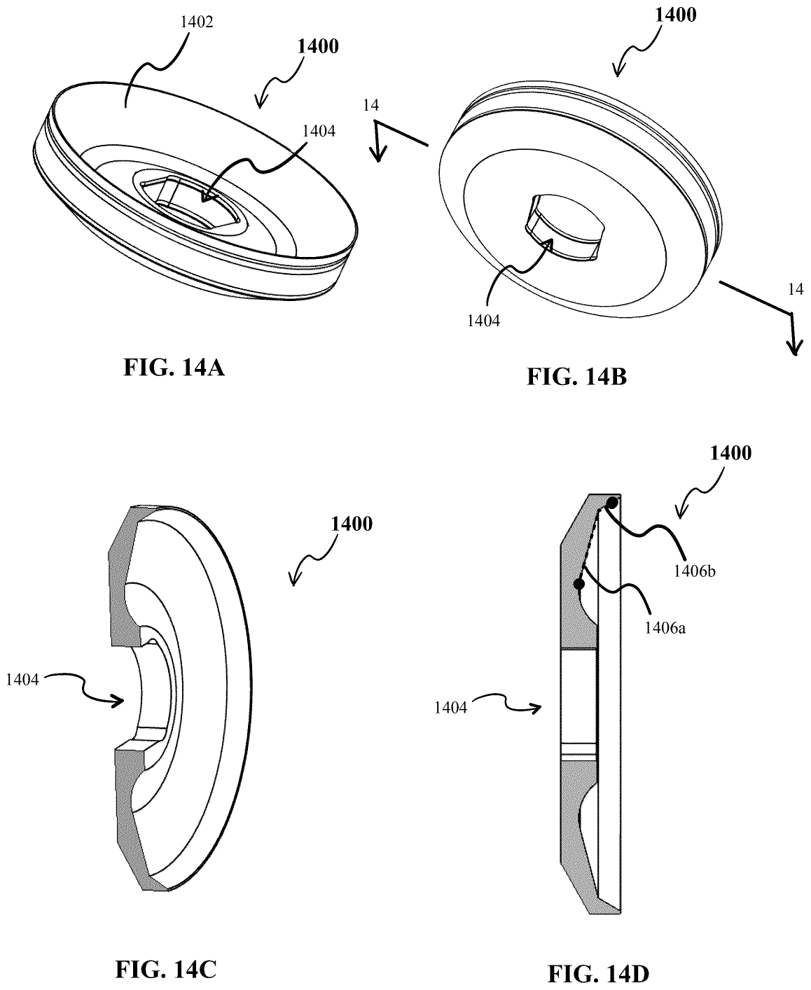

In the non-limiting embodiment depicted in this disclosure, the one or more centrifugally responsive weights 806 are ball bearings formed from a dense material, such as metal or a metallic alloy. Each of the ball bearings travel in a cross-sectionally expanding guidance channel 808 that is formed in part by the idler spider 1300, which is depicted in more detail in FIG. 13, and a ramped disk 1400, which is depicted in more detail in FIG. 14. Rotation of the tubular nozzle shaft 102 causes rotation of the centrifugal force converter 802, which imparts motion to each ball bearing. The guidance channel 808 causes each of the ball bearings to travel in a generally arcuate path, relative to the tubular nozzle shaft 102. As a result, at any point during the path of travel, each ball bearing has a force component exerted radially outward, e.g., in the direction of the housing body 300, and another force component exerted in the axial direction, e.g., in the direction of the set of brake disks 804, as shown in more detail in FIGS. 15A-15C.

The idler spider 1300, shown in more detail in FIG. 13, includes a plurality of sidewalls 1302 extending radially outwardly from the central aperture 1304, restricts the movement of the ball bearings to be in the radial direction, relative to the tubular nozzle shaft 102. The ramped disk 1400, which includes an inclined surface 1402 that has a slope that generally increases in the axial direction (i.e., normal to the diameter of the ramped disk) with increasing distance from its central aperture 1404, controls movement of the ball bearings in the axial direction. The idler spider 1300 and the ramped disk 1400 are separable from one another in the axial direction so that the guidance channels 808 have an expanding cross-sectional area. For example, at rest, i.e., in the absence of rotation, the idler spider 1300 and the ramped disk 1400′ are separated by a distance D1, as can be seen in FIG. 15A. (The prime notation for ramped disk depicted in FIGS. 15A-15C is used to differentiate the ramped disk from the ramped disk depicted in FIGS. 14A-14D. In particular, the ramped disk 1400 of FIGS. 14A-14D has a single inclined surface 1406a on which the ball bearings 806 can travel, whereas the ramped disk 1400′ of FIGS. 15A-15C have two different inclined surfaces on which the ball bearings 806 can travel.) The idler spider 1300 and the ramped disk 1400′ are separated by a distance D2, as can be seen in FIG. 15B, when rotation of the nozzle shaft 102 results in contact between the friction disks 1100 and the rotor disks 1200. The idler spider 1300 and the ramped disk 1400′ are separated by a distance D3, as can be seen in FIG. 15C, when the friction brake assembly 800 is at full travel. Full travel can correspond to fully worn brake disks, e.g., when the friction material 1106 is formed from an incompressible material and in a fully worn state, or when the friction material 1106 is formed from a compressible material and in a fully compressed state or a fully worn state. Axial travel of the components of the friction brake assembly 800 accommodates wear in the friction material 1106 or compression in the friction material 1106 (when applicable) to maintain a constant axial force regardless of the radial position of the ball bearings 806.

In some embodiments utilizing a compressible friction material 1106 and/or a progressive arc design on the inclined surface 1402 of the ramped disk that maintains a constant axial force regardless of the radial position of the ball bearings 806, when the tubular nozzle shaft 102 is rotating at maximum rotational velocity, the idler spider 1300 and the ramped disk 1400 are separated by a maximum distance of D3 due to travel of the ball bearings 806 in the axial direction and the contact between the brake disks 804. In these embodiments, when rotating at a rotational velocity between 0 and the maximum rotational velocity, the idler spider 1300 and the ramped disk 1400 are separated by a distance D2 that is between D1 and D3, which is also due to the travel of the ball bearings 806 and the contact between the brake disks 804. Increasing separation between the idler spider 1300 and the ramped disk 1400 can, in these embodiments, correspond to increasing magnitude of the centrifugal force, which corresponds to increasing magnitude of the axial force and thus an increase magnitude of the braking force imparted by the plurality of brake disks 804.

In the embodiment in which the set of centrifugal force converters 802 includes two or more centrifugal force converters, the axial force contributing to the magnitude of the braking force experienced by the plurality of brake disks 804 is the sum of the axial forces attributed to each of the centrifugal force converters. Thus, in the embodiment depicted in FIGS. 4, 5, 6, 8, 9, and 10, the axial force is the sum of the axial forces generated by centrifugal force converters 802a and 802b. The magnitude of the axial force can be modified/altered by changing the number of centrifugal force converters 802 implemented, the number of centrifugally responsive weights 806, the mass and/or density of the centrifugally responsive weights 806, and/or the departure angle(s) (i.e., the slope(s) or the angle(s) of curvature) on the face of each ramped disk 1400 or the face of the idler spider base 1306 (i.e., the surface engaging the centrifugally responsive weights 806. The magnitude of the axial force is reduced by the axial force introduced by the wave springs 810. By controlling the magnitude of the axial force and the selection of a particular number of brake disks 804 with a particular coefficient of friction, a nozzle apparatus assembly 100 is provided that can be tuned to accept a range of input torques and produce a desired output rotational speed.

With reference back to FIG. 8, each of the plurality of brake disks 804 are slidably mounted within the housing body 300, e.g., some of which are slidably mounted to the tubular nozzle shaft 102 and some of which are slidably mounted to the housing body 300. As a result, the axial forces imparted to the plurality of brake disks 804 causes the plurality of brake disks 804 to compress together more tightly. Because the brake disks are arranged in an alternating fashion, i.e., a rotor disk 1200 adjacent to a lined friction disk 1100 that is adjacent to a rotor disk, etc., only every other brake disk from the plurality of brake disks 804 rotates with along with the tubular nozzle shaft 102 while the remaining brake disks are rotationally fixed relative to the outer housing. Thus, increasing axial forces results in increasing braking forces on the brake disks 804, i.e., increased frictional forces exerted between each of the plurality of brake disks 804, which reduces the rotational speed of the tubular nozzle shaft 102 and the discharge head 700.

The friction brake assembly 800 can include one or more wave springs 810 disposed around the tubular nozzle shaft 102 and centered within the central aperture of each lined friction disk 1100, as can be seen in FIGS. 8, 9, and 11. The wave springs 810 can be used to maintain separation of the brake disks 804 in the absence of rotation of the tubular nozzle shaft 102, which allows rotation of the nozzle shaft 102 to begin at as low an input torque as possible. As the tubular nozzle shaft 102 begins to rotate, the axial force increases, which increases the compressive forces on the one or more wave springs 810 until the spring constant of the one or more wave springs 810 is overcome, allowing the brake disks 804 to engage one another. In addition, the wave springs 810 provide a biasing force that causes the idler spider 1300 and the ramped disk 1400 to return to the position depicted in FIG. 15A in the absence of rotation.

FIG. 11 is a plan view of a lined friction disk of the friction brake assembly in accordance with an illustrative embodiment. The lined friction disk 1100 is formed from a base plate 1102 with a central aperture 1104 passing therethrough. The central aperture 1104 should be sufficiently large so that when the lined friction disk 1100 is in the installed configuration within the housing body 300, the tubular nozzle shaft 102 can rotate freely without engaging the base plate 1102.

The lined friction disk 1100 is depicted with a wave spring 810 coaxially aligned within the central aperture 1104 of the lined friction disk 1100 to show the relative orientation of the two when installed along the tubular nozzle shaft 102 of the friction brake assembly 800.

The lined friction disk 1100 includes a friction liner 1106 disposed on at least one face of the base plate 1102. The friction liner 1106 is a surface configured to increase the frictional forces imparted on or by the lined friction disk 1100. The friction liner 1106 can be a feature or series of features formed onto the face(s) of the base plate 1100, like knurled texturing. Alternatively, the friction liner 1106 can be a separate layer adhered or otherwise affixed to the base plate 1102 and formed from any currently existing or later developed materials, e.g., the friction liner 1106 can be formed entirely, primarily, or at least partially from organic, inorganic, and/or metallic materials. A non-limiting example of the friction liner 1106 can include a condensed and compressed, matted fabric, such as reinforced felt.

In the non-limiting embodiment of this disclosure, the lined friction disk 1100 includes a set of teeth 1108 disposed around the outer circumference of the base plate 1102. The size and placement of the set of teeth 1108 correspond to the set of axial channels 304 disposed on the inner surface of the housing body 300. Engagement of the set of teeth 1108 within the set of axial channels 304 allows the lined friction disk 1100 to be slidably mounted within the housing body 300 but remain rotationally fixed. As the tubular nozzle shaft 102 rotates within the housing body 300, one or more rotor disks 1200 slidably mounted by rotationally fixed to the tubular nozzle shaft 102 engages the friction liner 1106 of the lined friction disk 1100. The braking force of the frictional brake assembly 800 is attributed to the frictional forces between the rotor disk(s) 1200 and the lined friction disk(s) 1100 and the number of alternating rotor disks 1200 and lined friction disks 1100 that form the plurality of brake disks 804. The number of rotor disks 1200 and lined friction disks 1100 included in plurality of brake disks 804 can be increased or decreased to achieve the desired output torque and/or rotational speed.

FIG. 12 is a plan view of a rotor disk of the friction brake assembly in accordance with an illustrative embodiment. Like the base plate 1102 of the lined friction disk 1100, the rotor disk 1200 can be formed from a suitably rigid material that can withstand the increased temperatures over extended periods of use, such as a metal, metallic alloy, or polymer.

The rotor disk 1200 includes a central aperture 1202 that is dimensioned to allow the rotor disk 1200 to be slidably engaged about the tubular nozzle shaft 102, but rotationally fixed relative to the tubular nozzle shaft 102 so that rotation of the tubular nozzle shaft 102 causes the rotor disk 1200 to also rotate. Slidability of the rotor disk 1200 along the tubular nozzle shaft 102 allows the axial force generated by the centrifugal force converters 802 to be distributed among the brake disks 804 to retard the rotational speed of the tubular nozzle shaft 102.

Each of the faces of the rotor disk 1200 can include friction-increasing features, such as a slotted surface or knurls, or heat dissipating features. In the depicted embodiment, the rotor disk 1200 includes a plurality of apertures 1204 arranged in a ring around the central aperture 1202. The plurality of apertures 1204 can reduce weight of the rotor disk 1200, increase heat dissipation, and increase frictional engagement with the friction liner 1106 of the lined friction disk 1100.

FIGS. 13A-13C are various views of an idler spider of the friction brake assembly in accordance with an illustrative embodiment. The idler spider 1300 is a dome-shaped component with a set of sidewalls 1302 disposed on the face of a flat, disk-shaped base 1306. The set of sidewalls 1302 can be integrally formed with the base 1306 or be formed separated from the base 1306 and subsequently attached via conventional means. The set of sidewalls 1302 extend radially outwardly from a central aperture 1304 that is dimensioned to allow the idler spider 1300 to be slidably mounted but rotational fixed to the tubular nozzle shaft 102. Slidability of the idler spider 1300 allows the idler spider 1300 to transmit an axial force generated by the ball bearings to the brake disks 804, which retards the rotational speed of the tubular nozzle shaft 102 and the attached nozzle head 700.

Adjacent pairs of sidewalls 1302 are spaced apart sufficiently to accommodate a centrifugally responsive weight 806, e.g., ball bearings in the depicted embodiment. The partial volume 1308 bounded by the base 1306 and a pair of adjacent sidewalls 1302 define part of the guidance channel 808. The opposing part of the guidance channel 808 is formed by the inclined surface of the ramped disk 1400. Each sidewall 1302 has a generally decreasing height H as the radial distance from the central aperture increases. The decreasing height H, shown in FIG. 13B, allows the idler spider 1300 to assume the generally dome-shaped, i.e., convex, surface that is complementary to the inclined surface 1402, i.e., concave, of the ramped disk 1400, shown in more detail in FIG. 14 that follows. The generally complementary shapes of the idler spider 1300 and the ramped disk 1400 allow the adjacent surfaces of the two halves of the centrifugal force converter 800 to be brought into closer proximity to one another in the assembled configuration. The idler spider 1300 and the ramped disk 1400 are physically separated from one another by the centrifugally responsive weights 806, i.e., the ball bearings in the depicted embodiment.

The sidewalls 1302 of the idler spider 1300 constrain movement of the centrifugally responsive weights 806, i.e., ball bearings, in the radial direction, relative to the tubular nozzle shaft 102 along a path 1310 shown in FIG. 13A. The path begins at an initial location 1312, corresponding to the location of a ball bearing when the tubular nozzle shaft 102 is at rest, i.e., in the absence of rotation. The path 1310 ends at a terminal location 1314, corresponding the location of the ball bearing when the tubular nozzle shaft 102 is rotating at maximum rotational velocity and the friction brake assembly 800 is at full travel, i.e., when the friction material 1106 is fully worn or fully compressed if formed from a compressible material.

In the depicted embodiment in FIGS. 13A-13D, the face of the idler spider 1300 is flat so that the ball bearings 806 traveling against the face of the idler spider 1300 move only in the radial direction relative to the idler spider 1300. In another embodiment, the face of the idler spider 1300 can be inclined to permit the ball bearings 806 traveling against the face of the idler spider 1300 to travel in a direction that includes a radial component as well as an axial component, relative to the idler spider 1300.

FIG. 13D is a perspective view of the idler spider engaging a plurality of ball bearings in accordance with an illustrative embodiment. The location of each of the ball bearings coincides with the initial location 1312, i.e., when the tubular nozzle shaft 102 is at rest.

FIGS. 14A-B are various views of a ramped disk of the friction brake assembly in accordance with an illustrative embodiment and FIGS. 14C-D are various section views of the ramped disk of the friction brake assembly in accordance with an illustrative embodiment, taken along lines 14-14 in FIG. 14B. The ramped disk 1400 has an inclined surface 1402 that forms part of the previously discussed guidance channel 808. When the set of centrifugal force converters 802 is in the assembly configuration, the inclined surface 1402 of the ramped disk 1400 is brought to face the dome-shaped sidewalls 1302 of the idler spider 1300.

The angle of departure of the inclined surface 1402 at any point along the direction of travel of a centrifugally responsive weight 806 in the guidance channel 808 determines the portion of the centrifugal force that is converted into an axial force, as described in more detail in FIGS. 15A-15C. The inclined surface 1402 can be defined by a single slope (or curvature) throughout, as depicted in FIGS. 14A-14D, or two or more slopes (or curvatures), as described in FIGS. 15A-15C. For example, in the cross-sectional views of the ramped disk 1400 in FIGS. 14C and 14D, the inclined surface 1402 has a first inclined section 1406a that has a first, constant angle of departure relative to the radial direction and a second inclined section 1406b that has a second, constant angle of departure relative to the radial direction. The second inclined section 1406b provides for overtravel protection to prevent the ball bearings 806 from contacting the inner surface of the housing body 300. Ball bearings 806 traveling along the inclined surface 1402 would travel along the first inclined section 1406a and the radial position of the ball bearings 806 can increase as the friction material 1106 wears (or as the friction material 1106 compresses if formed from compressible material), which corresponds to an increase in the centrifugal force and thus an increase in the axial force.

At the center of the ramped disk 1400 is an aperture 1404 sized and shaped to be slidably mounted but rotationally fixed around the tubular nozzle shaft 102 so that rotation of the tubular nozzle shaft 102 can cause the ramped disk 1400 to rotate in concert with the tubular nozzle shaft 102, but which allows the ramped disk 1400 to slide along length of the tubular nozzle shaft 102. Slidability of the ramped disk 1400 allows the ramped disk 1400 to transfer any axial force generated by an upstream centrifugal force converter to the centrifugally responsive weights, i.e., ball bearings, so that that the axial forces can be additive.

FIG. 15A-C are various lateral cross-sectional views of the friction brake assembly in various stages of operation in accordance with an illustrative embodiment. The friction brake assembly 1500 shown in FIG. 15A is housed in a nozzle assembly 100 at rest, i.e., in the absence of rotation. The friction brake assembly 1500 in FIG. 15C is housed in a nozzle assembly 100 that is rotating within the given torque input range and with worn or compressed friction material 1106, and the friction brake assembly 1500 in FIG. 15B is housed in a nozzle assembly 100 rotating within the given torque input range and with unworn or uncompressed friction material 1106.

In FIG. 15A, when the frictional brake assembly 1500 is at rest, the curvature of the ramped disk 1400 causes each of the ball bearings to remain at an initial position that corresponds to point 1312 in FIG. 13A. As the speed of the discharge nozzle 700 and the tubular nozzle shaft 102 increases, the rotational speed of the centrifugal force converter 802 increases, which in turn increases the force exerted on and by the ball bearings. In the absence of a ramped disk 1400, the force exerted by the ball bearing is wholly in the radially outward direction. However, the inclined surface 1402 of ramped disk 1400 causes each ball bearing to travel up the inclined surface 1402 of the ramped disk 1400. The direction of travel of a ball bearing traveling along the inclined surface 1402 of the ramped disk 1400 is represented by arrow 1502 in FIG. 15B and arrow 1504 in FIG. 15C. The distance traveled by the ramped disk 1400 in the axial direction relative to the frictional brake assembly 1500 at rest can be determined by calculating the difference between D1 and each of D2 or D3. The axial force exerted by each ball bearing 806 can be determined by calculating the axial component of the normal force exerted by the inclined surface 1402 on each of the ball bearings 806. The normal force exerted on the ball bearing 806 in FIG. 15B is represented by arrow 1506 can be broken down into a radial component and an axial component. The normal force exerted on the ball bearing 806 in FIG. 15C is represented by arrow 1508 can also be broken down into a radial component and an axial component. The relative lengths of the axial components of each of the normal forces 1506 and 1508 shows an inverse relationship between the slope of the inclined surface 1402 and the amount of the axial force exerted by each of the ball bearings 806. Increased axial force results in a greater frictional forces between the set of brake disks 804, which leads to increased braking of the brake disks 804.

In FIG. 15C, the layers of friction material 1106 on each of the lined friction disks 1100 are shown in a compressed state, which would occur when the friction material 1106 is made of a compressive material as previously described. If the friction material 1106 is made from a non-compressive material, like the type of brake pad material used in cars, then the friction material 1106 would not compress during use and the friction material 1106 depicted in FIG. 15C would represent lined friction disks 1100 near the end of their service life, i.e., worn out friction material 1106.

For the sake of simplicity, FIGS. 15A-15C depict an embodiment in which a single centrifugal force converter 802 is implemented. However, in other embodiments, like in FIG. 2, two or more centrifugal force converters 802 can be implemented. The axial force exerted on the set of brake disks 804 would then be the sum total of the axial forces generated by each of the centrifugal force converters 802, but offset by the force generated by the wave springs 810.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred embodiments, it will be understood by those skilled in the art that various changes in form and detail may be made therein without departing from the spirit and scope of the disclosure. The inventors expect skilled artisans to employ such variations as appropriate, and the inventors intend the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A nozzle apparatus assembly comprising:
a housing body;
a tubular nozzle shaft rotatably mounted within the housing body;
a nozzle head coupled to the tubular nozzle shaft, wherein:
the tubular nozzle shaft and the nozzle head define a portion of a fluid pathway extending from an inlet end of the housing body to a set of directional nozzles disposed at a discharge end of the nozzle head, and
the tubular nozzle shaft and the nozzle head are configured to rotate together in response to a discharge of a pressurized liquid from the set of directional nozzles; and
a friction brake assembly housed within the housing body, wherein the friction brake assembly is configured to convert a centrifugal force generated by a rotation of the tubular nozzle shaft and the nozzle head into an axial force that reduces a rate of rotation of the nozzle shaft and the nozzle head.

2. The nozzle assembly of claim 1, wherein the friction brake assembly further comprises:
at least one centrifugal force converter slidably mounted to the tubular nozzle shaft and rotatably fixed to the tubular nozzle shaft; and
at least one rotor disk, wherein the centrifugal force converter converts the centrifugal force into the axial force that increases a frictional force exerted on the at least one rotor disk to reduce the rate of rotation of the nozzle shaft and the nozzle head.

3. The nozzle apparatus assembly of claim 2, wherein the friction brake assembly further comprises:
at least one lined friction disk that includes a friction liner attached to a base plate of the lined friction disk, wherein:
the friction disk is coaxially aligned with the rotor disk,
the friction liner is configured to be operably engaged with the rotor disk, and
the frictional force is exerted on the at least one rotor disk by the friction liner.

4. The nozzle apparatus assembly of claim 3, wherein:
the at least one rotor disk comprises a plurality of rotor disks rotatably fixed to the tubular nozzle shaft,
the at least one friction disk comprises a plurality of friction disks non-rotatably mounted within the housing body, and
the plurality of rotor disks and the plurality of friction disks are arranged in alternating fashion.

5. The nozzle apparatus assembly of claim 4, wherein:
the at least one centrifugal force converter comprises a plurality of centrifugal force converters arranged in series; and
the axial force is formed from an axial force component attributed to each of the plurality of centrifugal force converters.

6. The nozzle apparatus assembly of claim 2, wherein the centrifugal force converter comprises:
at least one centrifugally responsive weight;
at least one guidance channel sized to receive the at least one centrifugally responsive weight, wherein:
the at least one guidance channel is configured to cause the at least one centrifugally responsive weight to travel along a path that is at least partially in an axial direction.

7. The nozzle apparatus assembly of claim 6, wherein the path is a generally arcuate path relative to the tubular nozzle shaft.

8. The nozzle apparatus assembly of claim 6, wherein the at least one centrifugally responsive weight is a ball bearing.

9. The nozzle apparatus assembly of claim 6, wherein the guidance channel is configured to have an expanding cross-sectional area that expands during the rotation of the tubular nozzle shaft and the nozzle head.

10. The nozzle apparatus assembly of claim 6, wherein the guidance channel is a volume of space defined by an idler spider and a ramped disk.

11. The nozzle apparatus assembly of claim 10, wherein the ramped disk includes an inclined surface with at least two different angles of departure.

12. The nozzle apparatus assembly of claim 1, wherein the housing body is configured to operate in an absence of a lubricating fluid.

13. The nozzle apparatus assembly of claim 1, wherein the housing body further comprises a lubricating fluid contained therein.

14. The nozzle apparatus assembly of claim 4, further comprising a plurality of wave springs, wherein spacing between each of the plurality of rotor disks and plurality of frictions disks is maintained by one of the plurality of wave springs.

15. The nozzle apparatus assembly of claim 6, wherein the axial force is adjustable by changing a number of the at least one centrifugally responsive weights, changing a mass and/or density of the centrifugally responsive weights, an angle of departure of the path of travel of the at least one centrifugally responsive weights.

16. A method of reducing a rate of rotation in a nozzle apparatus, the method comprising:
conveying a pressurized fluid through a fluid pathway extending from an inlet end of a housing body of the nozzle apparatus to a set of directional nozzles disposed at a discharge end of a nozzle head, wherein the nozzle head is coupled to a tubular nozzle shaft rotatably mounted within the housing body;
rotating the tubular nozzle shaft and the nozzle head together in response to a discharge of the pressurized liquid from the set of directional nozzles; and
converting, with a friction brake assembly housed within the housing body, a centrifugal force generated by the rotation of the tubular nozzle shaft and the nozzle head into an axial force that reduces the rate of rotation of the nozzle shaft and the nozzle head.

17. The method of claim 16, wherein the friction brake assembly comprises at least one centrifugal force converter slidably mounted to the tubular nozzle shaft and rotatably fixed to the tubular nozzle shaft, and wherein converting the centrifugal force into the axial force further comprises:
increasing a frictional force exerted on at least one rotor disk with the axial force, wherein the frictional force reduces the rate of rotation of the nozzle shaft and the nozzle head.

18. The method of claim 17, wherein the friction brake assembly comprises at least one lined friction disk that includes a friction liner operably engaged with the rotor disk, and wherein increasing the frictional force exerted on the at least one rotor disk further comprises:
increasing the frictional force on the at least one rotor disk by the friction liner.

19. The method of claim 17, wherein the centrifugal force converter comprises at least one centrifugally responsive weight that travels in an arcuate path that extends radially outwardly and axially.

20. The method of claim 19, wherein converting the centrifugal force into the axial force further comprises:
conveying the at least one centrifugally response weight along a guidance channel that defines the arcuate path.
